(19) United States
(12) Patent Application Publication
(10) Pub. No.: US 2020/0252420 A1
(43) Pub. Date: Aug. 6, 2020

(54) CYBER DEFENSE AND RESPONSE SYSTEM FOR BUILDINGS

(71) Applicant: Carrier Corporation, Palm Beach Gardens, FL (US)

(72) Inventors: Veronica Adetola, West Hartford, CT (US); Devu Manikantan Shila, West Hartford, CT (US)

(21) Appl. No.: 16/750,886

(22) Filed: Jan. 23, 2020

Related U.S. Application Data
(60) Provisional application No. 62/801,348, filed on Feb. 5, 2019.

(51) Int. Cl. H04L 29/06; F24F 11/49; F24F 11/63

(52) U.S. Cl. CPC H04L 63/1425; H04L 63/1441; F24F 11/63; F24F 11/49; H04L 63/1416

(57) ABSTRACT

A method for a building system includes determining a relationship between first data from a first building device and second data from a second building device. It is determined whether there is an anomaly based on the relationship. An automatic targeted control response is provided if the anomaly indicates an attack.

### CROSS-REFERENCE TO RELATED APPLICATIONS

This application claims priority to U.S. Provisional Application No. 62/801,348, which was filed on Feb. 5, 2019 and is incorporated herein by reference.

### STATEMENT REGARDING FEDERALLY SPONSORED RESEARCH OR DEVELOPMENT

This invention was made with government support under contract number DE-0E0000826 awarded by United States Department of Energy. The government has certain rights in the invention.

### BACKGROUND

This present disclosure relates generally to a defense and response system for buildings.

Buildings, such as university buildings, office buildings, residential buildings, and the like, incorporate multiple electrically powered systems. Some or all of these systems are smart systems including Internet, or other network connectivity which facilitates remote control and operation of the building system through computer networks.

Due to their connections to a computer network, smart building systems can be vulnerable to hacking, malware, or other malicious activity. In addition, smart and non-smart building systems can undergo anomalous behaviors due to malfunctions or other operational irregularities. The anomalous activity can be the result of an individual attempting to attack the building, an individual attempting to use one or more building systems to indirectly attack other building systems, the power grid, or other buildings, or the result of accidental non-malicious activities and malfunctions.

### SUMMARY

In one exemplary embodiment, a method for a building system includes determining a relationship between first data from a first building device and second data from a second building device. It is determined whether there is an anomaly based on the relationship. An automatic targeted control response is provided if the anomaly indicates an attack.

In a further embodiment of the above, it is determined whether the anomaly is an attack by detecting at least one of a change in network behavior, a discrepancy between the first data and the second data, and a discrepancy between the first or second data and a predetermined value.

In a further embodiment of any of the above, the predetermined value is input by an operator.

In a further embodiment of any of the above, the predetermined value is based on building data that was stored over time.

In a further embodiment of any of the above, the first and second building devices are connected to a wireless network.

In a further embodiment of any of the above, a first node is configured to gather the first data from the first building device and a second node is configured to gather the second data from the second building device.

In a further embodiment of any of the above, the first building device is on a first building and the second building device is on a second building.

In a further embodiment of any of the above, the attack is localized by determining a source of the anomaly.

In a further embodiment of any of the above, user feedback of the system is integrated for improved detection of the anomaly and attack localization.

In a further embodiment of any of the above, the targeted control response comprises disconnecting at least one of the first and second building devices from a network.

In a further embodiment of any of the above, the targeted control response comprises activating a resilient mode of operation.

In a further embodiment of any of the above, the building device is a component of an HVAC system.

In a further embodiment of any of the above, the building device is a component of a lighting system.

In another exemplary embodiment, a building system includes a first building system in communication with a first node and a second building system in communication with a second node. A cyber defense response system is in communication with the first node and the second node via a network. The cyber defense response system is configured to command a targeted control response when an anomaly is detected in one of the first node, the second node and the network.

In a further embodiment of any of the above, the first building system is on a first building and the second building system is on a second building.

In a further embodiment of any of the above, the cyber defense response system is configured to determine whether the anomaly indicates an attack based on data from the first and second nodes.

In a further embodiment of any of the above, the cyber defense response system is in communication with a building behavior database and a building automation system.

In a further embodiment of any of the above, at least one of the cyber defense response system, the building behavior database, and the building automation system is configured to receive input from an operator to improve anomaly detection over time and expedite an attack localization process.

In a further embodiment of any of the above, the targeted control response comprises disconnecting at least one of the first node, the second node, and the cyber defense response system from the network.

In a further embodiment of any of the above, the first building system is an HVAC system or a lighting system.

The embodiments, examples, and alternatives of the preceding paragraphs, the claims, or the following description and drawings, including any of their various aspects or respective individual features, may be taken independently or in any combination. Features described in connection with one embodiment are applicable to all embodiments, unless such features are incompatible.

### BRIEF DESCRIPTION OF THE DRAWINGS

FIG. 1 schematically illustrates an example building network.

FIG. 2 schematically illustrates an example cyber defense system for a building network.

FIG. 3 schematically illustrates an exemplary method.

### DETAILED DESCRIPTION

Smart building systems, or Cyber Physical Systems (CPS) infrastructures, may be susceptible to cyber attacks. Detection and response methods detect conditions that may be a result of such cyber attacks. However, known systems and methods detect anomalies in the system, and do not distinguish between cyber attacks and physical system faults, such as a failure of a particular system in the CPS. The system and method described herein distinguishes between cyber attacks and system faults, and provides an automated response when a cyber attack is detected.

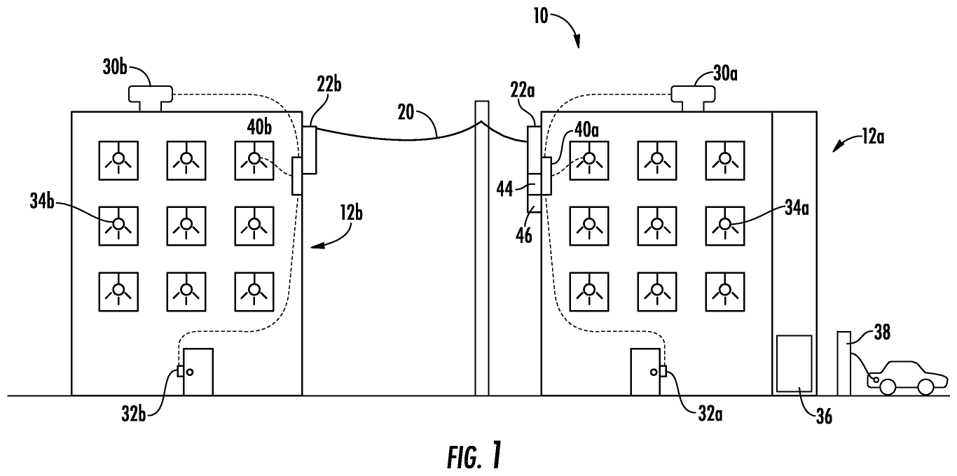

FIG. 1 schematically illustrates an example smart building system 10. The building system 10 includes a first building 12a and a second building 12b. The building system 10 may include additional buildings, in some examples. The building 12a may include a heating, ventilation, and cooling (HVAC) system 30a, a door lock system 32a, a lighting system 34a, an elevator system 36 and an electrical vehicle charging system 38, for example. The second building 12b may also include an HVAC system 30b, a door lock system 32b, a lighting system 34b, and/or other systems. The first and second buildings 12a, 12b may have all the same building systems, or some different building systems. The disclosed example building systems 30-38 are exemplary in nature and any number of additional building systems can be incorporated into the buildings 12a, 12b and receive the benefits of the system and method disclosed herein.

In an example embodiment, each of the buildings 12a, 12b is connected to a power line 20 via grid interconnects 22a, 22b. Each of the building systems 30-38 may draw operational power from a building power distribution system, which is connected to the grid interconnect 22a, 22b, and draws power from the external power grid to power the building systems 30-38. Due to the reliance on drawing power through the grid interconnect 22, each of the building systems 30-38 is referred to as being “behind the meter”. Although the buildings 12a, 12b are illustrated as being connected to the same power line 20, they may receive power from different power lines in some examples.

Each building 12a, 12b includes a respective computer network node 40a, 40b connected to at least some of the building systems 30-38. The nodes 40a, 40b collect information from each of the building systems. In some examples, the nodes 40a, 40b may be configured to detect the power characteristics being provided to the building 12a, 12b through the grid interconnect 22a, 22b. The nodes 40a, 40b may detect information such as current, voltage, frequency, active and reactive power, rate of change of frequency, and the like. In the illustrated example, the smart building systems are connected via wireless connections, although it should be appreciated that any other data connection can be utilized. The nodes 40a, 40b may receive data from the building systems via an external network, such as the Internet, for example.

The system 10 may include a building automation system 46 that sends signals to the nodes 40a, 40b and/or the building systems 30-38. In the illustrated example, the building automation system 46 is located on the building 12a, but in other examples, the building automation system 46 may be located remotely. The building automation system 46 may provide signals to all of the buildings 12a, 12b in the system 10, or to only some of the buildings 12a, 12b. The building automation system 46 may automate some or all of the example building systems 30-38. For example, the building automation system 46 may be programmed to automatically control the HVAC systems, 30a, 30b. The building automation system 46 may be connected to an external network, such as the Internet, to allow authorized users to access and control the building systems 30-38 from remote locations and from throughout the buildings 12a, 12b.

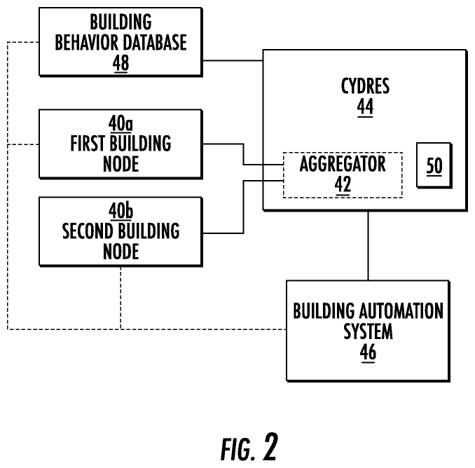

As shown in FIG. 2, and with continuing reference to FIG. 1, the system 10 includes a cyber defense response system (CYDRES) 44. The cyber defense response system 44 may include a modem or aggregator 42 in communication with the nodes 40a, 40b from each of the buildings 12a, 12b in the system 10. The aggregator 42 is, in turn, connected to an external network, such as the Internet, and may allow authorized users to access and control the building systems 30-38. In some embodiments, the aggregator 42 is integrated with the cyber defense response system 44. In other embodiments, the cyber defense response system 44 is separate from the aggregator 42, and they communicate through a wired or wireless connection. The building automation system 46 is in communication with the cyber defense response system 44. The building automation system 46 may be integrated into the cyber defense response system 44, in some examples.

The cyber defense response system 44 includes a computing device 50, which may include one or more controllers comprising a processor and memory. The computing device 50 may include a hardware device for executing software, particularly software stored in memory, such as a cyber attack detection algorithm. The computing device 50 may include a custom made or commercially available processor, a central processing unit (CPU), an auxiliary processor among several processors associated with the computing device 50, a semiconductor based microprocessor (in the form of a microchip or chip set), or generally any device for executing software instructions. The memory can include any one or combination of volatile memory elements (e.g., random access memory (RAM, such as DRAM, SRAM, SDRAM, VRAM, etc.)) and/or nonvolatile memory elements (e.g., ROM, hard drive, tape, CD-ROM, etc.). Moreover, the memory may incorporate electronic, magnetic, optical, and/or other types of storage media. Note that the memory can also have a distributed architecture, where various components are situated remotely from one another, but can be accessed by the processor.

The software in the memory may include one or more separate programs, each of which includes an ordered listing of executable instructions for implementing logical functions. A system component embodied as software may also be construed as a source program, executable program (object code), script, or any other entity comprising a set of instructions to be performed. When constructed as a source program, the program is translated via a compiler, assembler, interpreter, or the like, which may or may not be included within the memory.

The controller can be configured to execute software stored within the memory, to communicate data to and from the memory, and to generally control operations of the computing device 50 pursuant to the software. Software in memory, in whole or in part, is read by the processor, perhaps buffered within the processor, and then executed. This software may be used to analyze data from building systems to detect anomalies and determine whether the data indicate that the anomaly is the result of a cyber attack, for example.

The building automation system 46 and cyber defense response system 44 can then detect malicious activity occurring in one or more of the building systems 30-38 via embedded algorithms and the data from the building systems collected from the nodes 40a, 40b and/or building power characteristics. The cyber defense response system 44 compares data from the first node 40a to the second node 40b to determine anomalies. In one embodiment, the cyber defense response system 44 is connected to the nodes 40a, 40b, and the building automation system 46 wirelessly, such as via BLUETOOTH signaling protocol (IEEE 802.15.1), WiFi (IEEE 802.11), Zigbee (IEEE 802.15.4), Near-Field Communication (NFC), or another signaling protocol, for example.

The cyber defense response system 44 may also compare the data with a building behavior database 48 to help detect anomalies. The building behavior database 48 may include set values input by an operator for expected building behavior, and/or may store data over time to further improve algorithms. In an embodiment, the expected power characteristics of the building systems 30-38 may be continuously adapted in the cyber defense response system 44, and the system can account for seasonal variations in expected power characteristics. By way of example, the power characteristics of an air conditioner system will differ from those of a heating system, and the corresponding effect on the building power system will be distinct between a winter season and a summer season. In some embodiments, an operator can input feedback to the system, such that algorithms for localization and response are improved over time.

The cyber defense response system 44 is configured to detect anomalies in the system 10 by comparing data from the nodes 40a, 40b, the building behavior database 48, and the network. An anomaly in the system 10 may be due to a fault in one of the building systems 30-38, such as a failure of the HVAC system 30a or another building system, or may be a malicious cyber attack. If the anomaly is due to a failure of a building system, then the response might be to alert an operator so that the operator can fix the building system. However, if the anomaly is due to a cyber attack, a different response may be taken.

In one example, when a cyber attack or other malicious activity on one or more of the building systems 30-38 is launched using invalid commands, malware, or by changing the control parameters, the building systems 30-38 behave abnormally resulting in an anomaly in the power characteristics of the power passing through the grid interconnect 22. In an example, the nodes 40a, 40b and the cyber defense response system 44 are connected to a network, and the cyber defense response system 44 analyzes network behavior, such as traffic and delay, and system response. During a cyber attack, the attack may push a detectable or notable amount of data into the system 10. Thus, an increase in data traffic detected by the cyber defense response system 44 may be indicative of a cyber attack.

Comparing data from nodes 40a, 40b across different buildings 12a, 12b helps distinguish system faults from cyber attacks. For example, if a building system, such as an HVAC system 30a breaks down, it will not occur simultaneously across multiple buildings. However, a cyber attack may affect HVAC systems 30a, 30b across multiple buildings simultaneously. When an anomaly is detected across multiple buildings, it is likely a cyber attack.

If the anomaly detected is likely due to a cyber attack, the system 10 will respond with a targeted control response. In an embodiment, the system 10 commands the targeted control response automatically. The targeted control response may include automatically switching the building 12a, 12b to a resilient mode of operation based on the localized threat and estimated impact. The targeted control response may further include automated isolation and restoration of data and/or activation of resilient control logic. In one example, the response includes shutting down the system 10 to prevent the attack from infiltrating any further into the system 10 or any of the example building systems. The response may be to shut down the cyber defense response system 44, or to disconnect the cyber defense response system 44 and/or nodes 40a, 40b from the network. In another example, the response includes disconnecting the particular targeted building system 30-38 from the network. This automated response occurs quickly and may help mitigate harm from the attack.

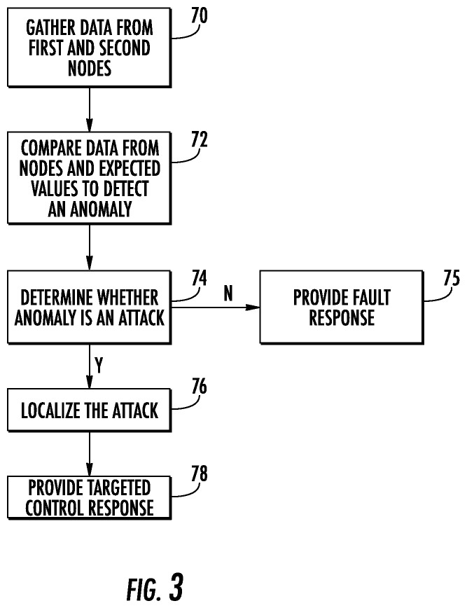

FIG. 3 summarizes an example method of detecting and responding to anomalies. The cyber defense response system 44 gathers data from the nodes 40a, 40b located on different buildings 12a, 12b at 70. The cyber defense response system 44 compares the data from the first node 40a with the data from the second node 40b at 72. The cyber defense response system 44 may also compare the data from the nodes 40a, 40b with expected values, such as values input by an operator or gathered over time from the building behavior database 48 at 72. When data from one or more of the nodes 40a, 40b deviates from the expected values, an anomaly is detected.

The cyber defense response system 44 analyzes the data and system to determine whether the detected anomaly is based on or resulting from a cyber attack or a system fault at 74. In one example, the cyber defense response system 44 analyzes network behavior, such as traffic and delay. In another example, the cyber defense response system 44 analyzes the variance of the data between the anomaly and the other nodes 40a, 40b and/or from the building behavior database 48. If the anomaly is not considered an attack, the cyber defense response system 44 provides a fault response at 75. In one example, the fault response includes sending an alert to an operator. If the anomaly is determined to be due to an attack, the cyber defense response system 44 localizes the attack at 76 to determine where the cyber attack is coming from and/or which building systems may be affected. The localization is based on analyzing data across building systems. For example, the cyber defense response system 44 may analyze individual equipment power characteristics, such as the installed HVAC 30a, 30b, the lighting systems 34a, 34b, power consumed by the building systems, and/or building system modes of operation and control data from the building automation system 46.

When a cyber attack is detected, the cyber defense response system 44 will respond with a targeted control response at 78. In one example, the response will include shutting down the system 10 or a portion of the system 10 to prevent the attack from infiltrating any further into the system 10. In another example, the response will include disconnecting a building system from the network. For example, at least one of the buildings 12a, 12b, nodes 40a, 40b, and/or building systems 30-38 may be disconnected. In other examples, the building behavior database 48 and/or building automation system 46 may be disconnected from the network. In an embodiment, the targeted control response is automated.

The disclosed system and method analyze data from the system to determine whether an anomaly is a malicious cyber attack or a system fault. The disclosed system and method further helps mitigate the impact of a successful attack on building devices by providing means to locate, validate, and automatically respond to cyber attacks.

It is further understood that any of the above described concepts can be used alone or in combination with any or all of the other above described concepts. Although an embodiment of this invention has been disclosed, a worker of ordinary skill in this art would recognize that certain modifications would come within the scope of this invention. For that reason, the following claims should be studied to determine the true scope and content of this invention.

What is claimed is:

1. A method for a building system, comprising:
determining a relationship between first data from a first building device and second data from a second building device;
determining whether there is an anomaly based on the relationship; and
providing an automatic targeted control response if the anomaly indicates an attack.

2. The method of claim 1, comprising:
determining whether the anomaly is an attack by detecting at least one of a change in network behavior, a discrepancy between the first data and the second data, and a discrepancy between the first or second data and a predetermined value.

3. The method of claim 2, wherein the predetermined value is input by an operator.

4. The method of claim 2, wherein the predetermined value is based on building data that was stored over time.

5. The method of claim 1, wherein the first and second building devices are connected to a wireless network.

6. The method of claim 1, wherein a first node is configured to gather the first data from the first building device and a second node is configured to gather the second data from the second building device.

7. The method of claim 1, wherein the first building device is on a first building and the second building device is on a second building.

8. The method of claim 1, comprising
localizing the attack by determining a source of the anomaly.

9. The method of claim 8, comprising:
integrating user feedback of the system for improved detection of the anomaly and attack localization.

10. The method of claim 1, wherein the targeted control response comprises disconnecting at least one of the first and second building devices from a network.

11. The method of claim 1, wherein the targeted control response comprises activating a resilient mode of operation.

12. The method of claim 1, wherein the building device is a component of an HVAC system.

13. The method of claim 1, wherein the building device is a component of a lighting system.

14. A building system, comprising:
a first building system in communication with a first node;
a second building system in communication with a second node;
a cyber defense response system in communication with the first node and the second node via a network, the cyber defense response system configured to command a targeted control response when an anomaly is detected in one of the first node, the second node and the network.

15. The building system of claim 14, wherein the first building system is on a first building and the second building system is on a second building.

16. The building system of claim 14, wherein the cyber defense response system is configured to determine whether the anomaly indicates an attack based on data from the first and second nodes.

17. The building system of claim 14, wherein the cyber defense response system is in communication with a building behavior database and a building automation system.

18. The building system of claim 17, wherein at least one of the cyber defense response system, the building behavior database, and the building automation system is configured to receive input from an operator to improve anomaly detection over time and expedite an attack localization process.

19. The building system of claim 14, wherein the targeted control response comprises disconnecting at least one of the first node, the second node, and the cyber defense response system from the network.

20. The building system of claim 14, wherein the first building system is an HVAC system or a lighting system.
